(19) United States
(12) Patent Application Publication
(10) Pub. No.: US 2025/0245245 A1
(43) Pub. Date: Jul. 31, 2025

(54) METHOD AND SYSTEM FOR VISUALIZING APPLICATION VITALS ACROSS AN ENTERPRISE USING ARTIFICIAL INTELLIGENCE

(71) Applicant: TEACHERS INSURANCE AND ANNUITY ASSOCIATION OF AMERICA, New York, NY (US)

(72) Inventors: Jaya Laxman Satish Babu Tummala, Concord, NC (US); Balakrishna Sagineni, Wilmington, DE (US); Juan Carlos Aviles Castellanos, Austin, TX (US); Brett Moyer, Huntersville, NC (US); Synthia Crittenden Baker, Dallas, NC (US); Jakkinpali Murty, Harrisburg, NC (US); Pravinraj Radha, Bangalore (IN); Venkatesh Guru Moorthy, Concord, NC (US); Kennedy Savariapitchai, Tamil Nadu (IN); Pankaj Pawar, Hadapsar Po (IN); Omkumar Atthangikavanoor Chandrasekaran, Harrisburg, NC (US)

(21) Appl. No.: 18/607,386

(22) Filed: Mar. 15, 2024

(30) Foreign Application Priority Data
Jan. 30, 2024 (IN) 202411006111

(51) Int. Cl. G06F 16/28; G06F 16/242; G06F 16/248

(52) U.S. Cl. CPC G06F 16/285; G06F 16/243; G06F 16/248

(57) ABSTRACT

A method, system and computer-readable medium for visualizing application vitals may include receiving and querying structured data; causing display of a view; querying a cloud infrastructure and/or an enterprise database in parallel, storing application vitals; synchronizing the application vitals with the enterprise memory server; comparing the application vitals with a cloud-ready assessment parameters; generating cloud categories by processing the cloud-ready assessment parameters using a trained classification model; receiving requested data; updating the view to include the requested data; and causing display of the view.

### TECHNICAL FIELD

The present disclosure generally relates to method and systems for visualizing enterprise application vitals, and more particularly, to training and utilizing artificial intelligence to receive and process responses from a user to output an intended view.

### BACKGROUND

Large-scale enterprises expend significant time and resources accumulating information about their applications. Evaluating an organization's applications and overall implementations is particularly challenging when some applications are locally hosted, and others are hosted by third party cloud services. Further hindering the accumulation of data are the visualization techniques employed.

Many of these challenges are a result of inefficient data compilation techniques and inadequate visualization methods. Conventional techniques require Boolean search operators (e.g., AND, OR, NOT) and search methods that do not provide a wide enough breadth of searching and visualization for organizational leadership to make informed decisions. These conventional techniques also suffer from time and computationally intensive methods. Overall, conventional techniques suffer from numerous drawbacks that limit the effectiveness and efficiency of decision making when compiling and visualizing information about an organization's applications spread between local and cloud-based hosting platforms.

Accordingly, a need exists for methods and systems of generating and providing dynamic visualization across an enterprise using artificial intelligence to streamline the process for an enterprise decision maker and provide a clear picture of an enterprise's application vitals.

### SUMMARY

In one aspect, a computer-implemented method for visualizing application vitals includes (1) receiving, by one or more processors, a structured data set; (2) querying, by the one or more processors, the structured data set for a person of interest; (3) causing a user device to display a view including: (i) the person of interest, and (ii) at least a portion of the structured data set corresponding to employees subordinate to the person of interest; (4) querying, by the one or more processors, a cloud infrastructure and/or an enterprise database in parallel, wherein the querying includes: (i) retrieving a plurality of application vitals from a plurality of enterprise applications with respect to the cloud infrastructure, and (ii) retrieving a plurality of application vitals from the plurality of enterprise applications with respect to the enterprise database, wherein, the application vitals include a plurality of health statistics with respect to the plurality of enterprise applications; (5) storing, by an enterprise memory server, the plurality of application vitals from the plurality of enterprise applications; (6) synchronizing, by the one or more processors, the plurality of application vitals from the plurality of enterprise applications with the enterprise memory server; (7) comparing, by the one or more processors, the plurality of application vitals with a plurality of cloud-ready assessment parameters; (8) generating one or more cloud categories corresponding to the enterprise applications by processing the application vitals and the cloud-ready assessment parameters using a trained classification model; (9) receiving, requested data from a user device; (10) updating, by the one or more processors, the view to include the requested data; and (11) causing the user device to display the view.

In yet another exemplary embodiment the present disclosure may be a system for visualizing application vitals. The system may include one or more processors; and one or more memories having stored thereon instructions that, when executed by the one or more processors, cause the system to: (1) receive a structured data set; (2) query the structured data set for a person of interest; (3) cause a user device to display a view including: (i) the person of interest, and (ii) at least a portion of the structured data set corresponding to employees subordinate to the person of interest; (4) query a cloud infrastructure and/or an enterprise database in parallel, wherein the querying includes: (i) performing a retrieval of a plurality of application vitals from a plurality of enterprise applications with respect to the cloud infrastructure, and (ii) performing a retrieval of a plurality of applications vitals from the plurality of enterprise applications with respect to the enterprise database, wherein the application vitals include a plurality of health statistics with respect to the plurality of enterprise applications; (5) store the plurality of application vitals from the plurality of enterprise applications; (6) synchronize the plurality of application vitals from the plurality of enterprise applications with an enterprise memory server; (7) compare the plurality of application vitals with a plurality of cloud-ready assessment parameters; (8) generate one or more cloud categories corresponding to the enterprise applications by processing the application vitals and the cloud-ready assessment parameters using a trained classification model; (9) receive, by a user device, requested data in a text query from a user input; (10) update the view to include the requested data; and (11) cause the user device to display the view.

Another exemplary embodiment the present disclosure may be a tangible machine-readable medium comprising instructions for visualizing application vitals that, when executed, cause a machine to at least: (1) receive a structured data set; (2) query the structured data set for a person of interest; (3) cause a user device to display a view including: (i) the person of interest, and (ii) at least a portion of the structured data set corresponding to employees subordinate to the person of interest; (4) query a cloud infrastructure and/or an enterprise database in parallel, wherein the querying includes: (i) performing a retrieval of a plurality of application vitals from a plurality of enterprise applications with respect to the cloud infrastructure, and (ii) performing a retrieval of a plurality of applications vitals from the plurality of enterprise applications with respect to the enterprise database, wherein the application vitals include a plurality of health statistics with respect to the plurality of enterprise applications; (5) store the plurality of application vitals from the plurality of enterprise applications; (6) synchronize the plurality of application vitals from the plurality of enterprise applications with an enterprise memory server; (7) compare the plurality of application vitals with a plurality of cloud-ready assessment parameters; (8) generate one or more cloud categories corresponding to the enterprise applications by processing the application vitals and the cloud-ready assessment parameters using a trained classification model; (9) receive requested data in a text query from a user input; (10) update the view to include the requested data; and (11) cause the user device to display the view.

### BRIEF DESCRIPTION OF THE DRAWINGS

The figures described below depict various aspects of the system and methods disclosed therein. It should be understood that each figure depicts an embodiment of a particular aspect of the disclosed system and methods, and that each of the figures is intended to accord with a possible embodiment thereof. Further, wherever possible, the following description refers to the reference numerals included in the following figures, in which features depicted in multiple figures are designated with consistent reference numerals.

There are shown in the drawings arrangements which are presently discussed, it being understood, however, that the present embodiments are not limited to the precise arrangements and instrumentalities shown, wherein:

FIG. 1 depicts an exemplary computing environment in which various embodiments of the present disclosure may be implemented, according to some aspects.

FIG. 2 depicts an exemplary enterprise/organizational hierarchy in which various embodiments of the present disclosure may be implemented, according to some aspects.

FIG. 3 depicts an exemplary flowchart for user request processing, in accordance with various aspects described herein.

FIG. 4 depicts an exemplary flowchart for data retrieval and classification in accordance with various aspects described herein.

FIG. 5 depicts an exemplary parallel computing environment for querying application vitals, in accordance with various aspects described herein.

FIG. 6A depicts an exemplary graphical user interface (GUI) that may be displayed on a user device, in accordance with various aspects described herein.

FIG. 6B depicts an exemplary list of cloud-ready assessment parameters in accordance with various aspects described herein.

The figures depict preferred embodiments for purposes of illustration only. One skilled in the art will readily recognize from the following discussion that alternative embodiments of the systems and methods illustrated herein may be employed without departing from the principles of the invention described herein.

### DETAILED DESCRIPTION

As used herein, the term “application vitals” generally refers to any kind of statistic or information about the health, performance, authorship, functionality, etc. of an enterprise application. “Application vitals” may refer to one or more CPU utilization statistics, one or more memory utilization statistics, one or more network utilization statistics, one or more network latency statistics, etc. “Application vitals” may be or include one or more of: a number, a text string, a file, a document, or any other suitable data/datatype or combinations thereof (e.g., one .csv file, five .data files, one .json file, etc.).

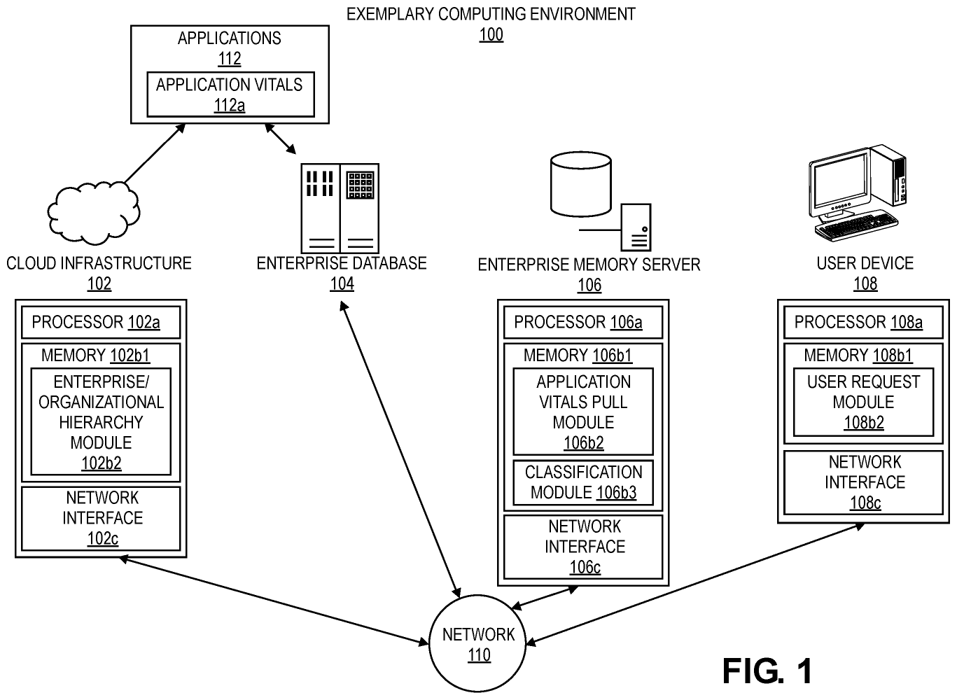

As previously mentioned, the systems and methods of the present disclosure generally relate to visualizing application vitals across an enterprise through the use of Artificial intelligence. To provide a better understanding of the systems and methods described herein, FIG. 1 depicts an exemplary computing environment in which techniques of the present disclosure may be implemented, according to some aspects. As described, conventional techniques suffer from inefficient and inadequate data compilation, processing, and visualization techniques. Therefore, to ameliorate the issues experienced utilizing conventional techniques, the techniques of the present disclosure may employ parallel data querying and processing of local and cloud-based application vitals using a trained classification model to aid in visualization. Moreover, the use by a computing device of an organizational/enterprise hierarchy in conjunction with the application vitals aids visualization of an enterprises strengths and weaknesses.

AppVitals is about engineering and architecture posture management of applications. AppVitals provides a view on the health of a portfolio of applications that can be a combination to make a platform, initiative, value stream, or customer journey. AppVitals focuses on posture management to understand in an automated fashion the current architectural state, engineering, and modernization standards as well as the risk an enterprise has. The dimensions can be modernization centric (like cloud), or adoption of a new framework, like enterprise Digital Orchestration Technology-Tetris Adoption Maturity Score (eDOT-TAMS), or risk centric such as end of life (EOL), resiliency, tech debt based on versions or architecture centric to get automated assessment score or engineering standards like adoption of development, security, and operations (DevSecOps), etc.

AppVitals follows the principles: AppVitals looks at both build time as well as runtime dependencies to understand overall posture. AppVitals uses automated system knowledge as well as human inputs to marry both information to get to the truth that is not clouded by one dimension. AppVitals use more intelligent automation driven via various integrations across a plethora of systems as well as leveraging aggregate build time and runtime data from various systems. AppVitals may leverage the data to provide intelligent assessments using machine learning (ML) and generative artificial intelligence (GenAI) capabilities.

### Exemplary Computing Environment

FIG. 1 depicts an exemplary computing environment 100 in which various embodiments of the present disclosure may be implemented, in some aspects. Generally, the exemplary computing environment 100 may be or include the various computing devices and/or components that execute some/all of the functions described herein. The exemplary computing environment 100 may include and/or otherwise utilize one or more computing devices (e.g., on-premise server(s), cloud-based server(s), desktop/laptop computers, smartphones and/or other smart devices, or the like) that are communicatively connected (e.g., via a network connection) to one another and are configured to transmit, receive, and/or process data related to the application vitals corresponding to an entity/organization that owns and/or otherwise accesses/utilizes the computing devices. The exemplary computing environment 100 may include a cloud infrastructure 102, an enterprise database 104, an enterprise memory server 106, and a user device 108. Each of these computing devices may be communicatively coupled to an electronic network 110.

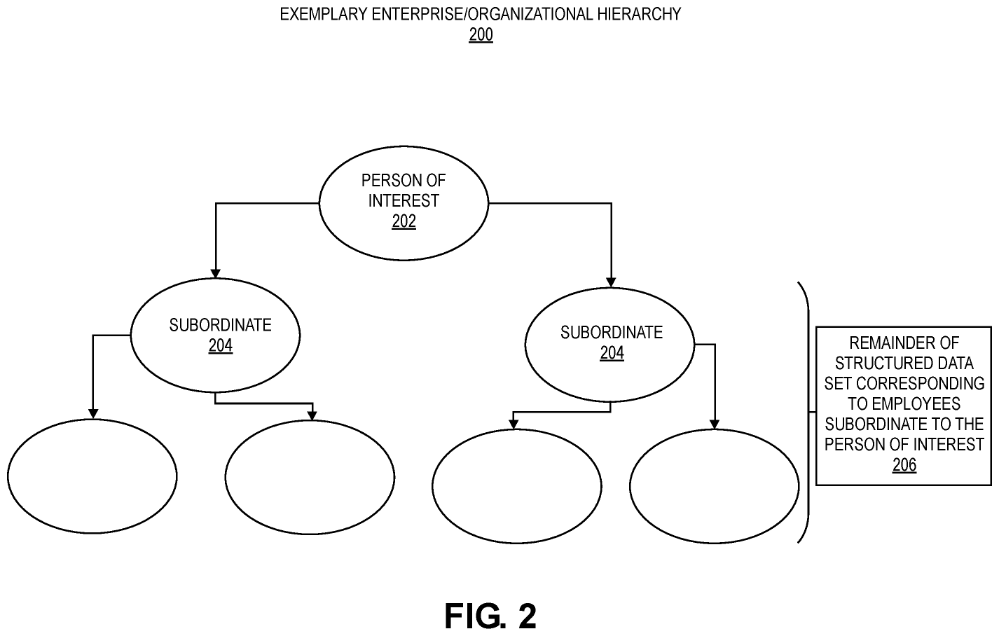

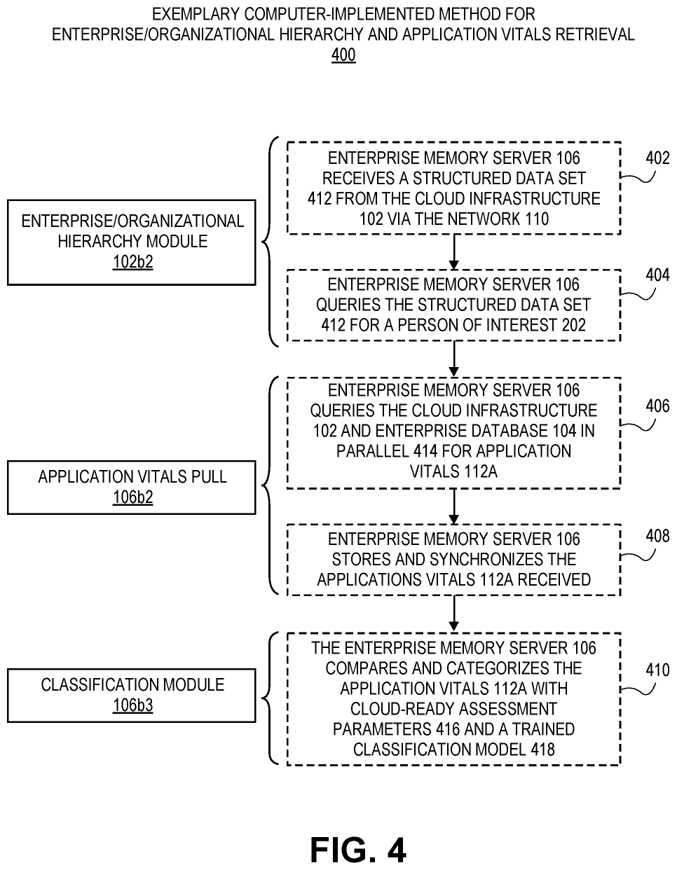

The cloud infrastructure 102 may include one or more processors 102a, a memory 102b1, and a network interface 102c. The memory 102b1 may further include an enterprise/organizational hierarchy module 102b2. In general, the enterprise/organizational hierarchy module 102b2 receives and queries an enterprise/organizational hierarchy corresponding to an internal/proprietary organizational chart and/or an organizational chart hosted by a third-party provider (e.g., a Workday organizational chart). For an exemplary enterprise/organizational hierarchy see FIG. 2. For further description of the enterprise/organizational hierarchy module 102b2 see FIG. 4.

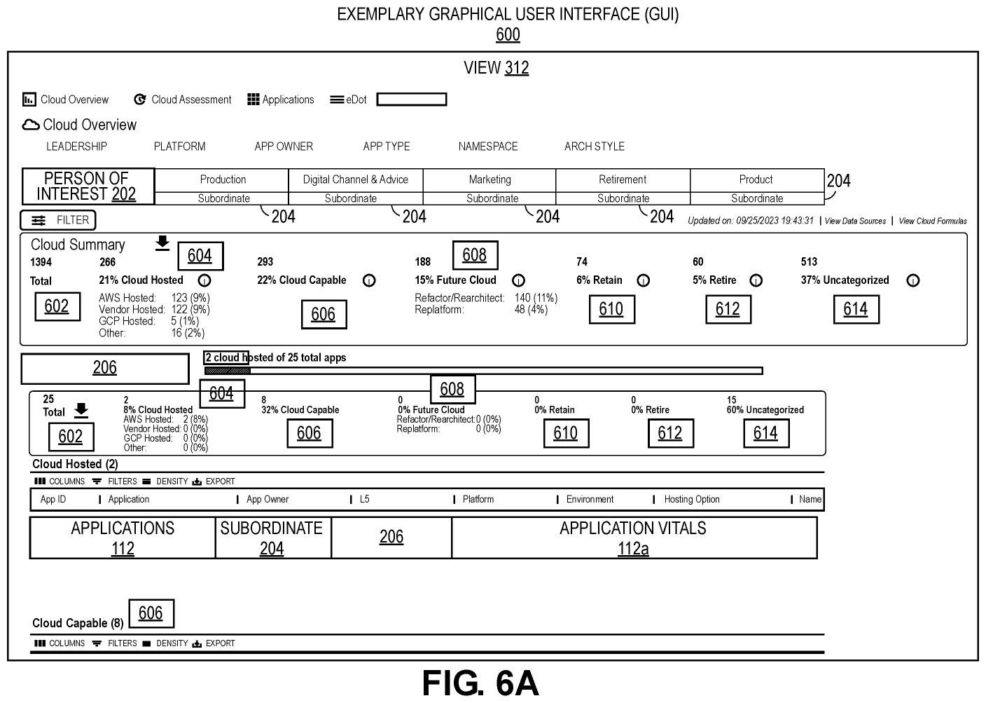

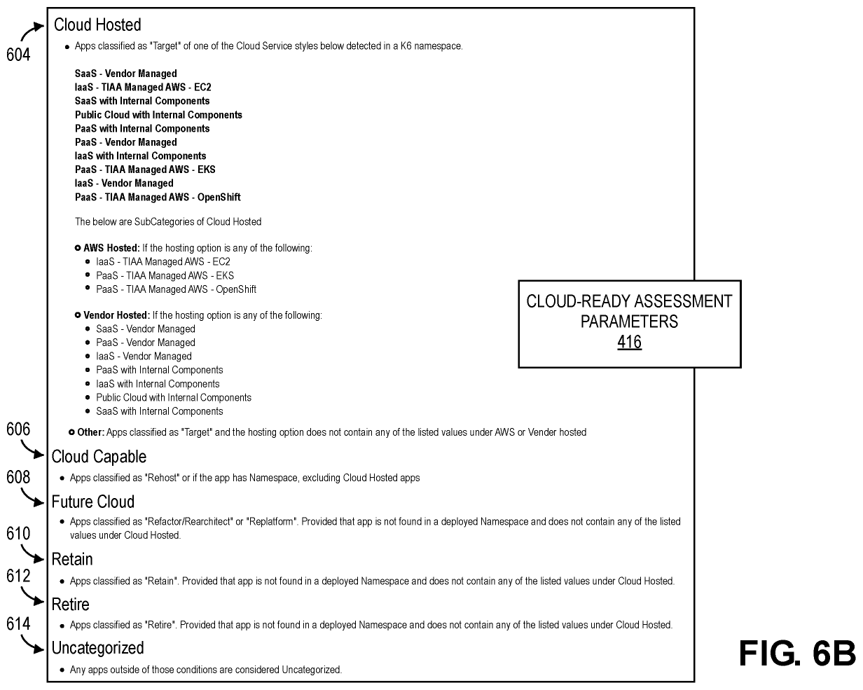

The cloud infrastructure 102 may host a plurality of applications 112 with a respective set of applications vitals 112a. As described, the application vitals 112a may generally include health statistics about the respective applications. For further description of the kinds of health statistics included in the application vitals 112a see FIG. 6A.

The enterprise database 104 may include the use of various enterprise database systems for hosting applications (e.g., on-premises hosting, colocation hosting, managed hosting, hybrid-cloud hosting, etc.). The enterprise database 104 may host a plurality of applications 112 each with respective corresponding applications vitals 112a. Again, application vitals 112a may generally include health statistics about the respective application.

While the applications 112 and associated application vitals 112a are depicted in FIG. 1 as hosted on the cloud infrastructure 102 and enterprise database 104 it should be appreciated that the applications 112 and associated application vitals 112a can be hosted on any of the components of the exemplary computing environment (e.g., enterprise memory server 106, user device 108) or any other suitable computing system.

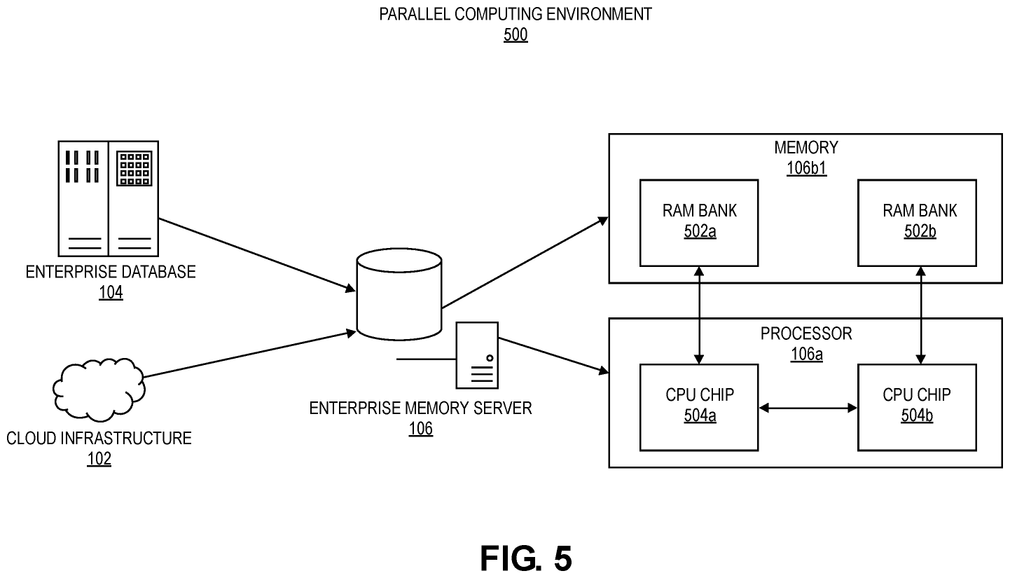

The enterprise memory server 106 may include the use of various enterprise servers (e.g., Dell PowerEdge, IBM Power Systems, Cisco UCS, etc.). The enterprise memory server 106 may include one or more processors 106a and a memory 106b1. The memory 106b1 may include an application vitals pull module 106b2 and a classification module 106b3. The application vitals pull module 106b2 and the classification module 106b3 are further described below in reference to FIG. 4 and FIG. 5.

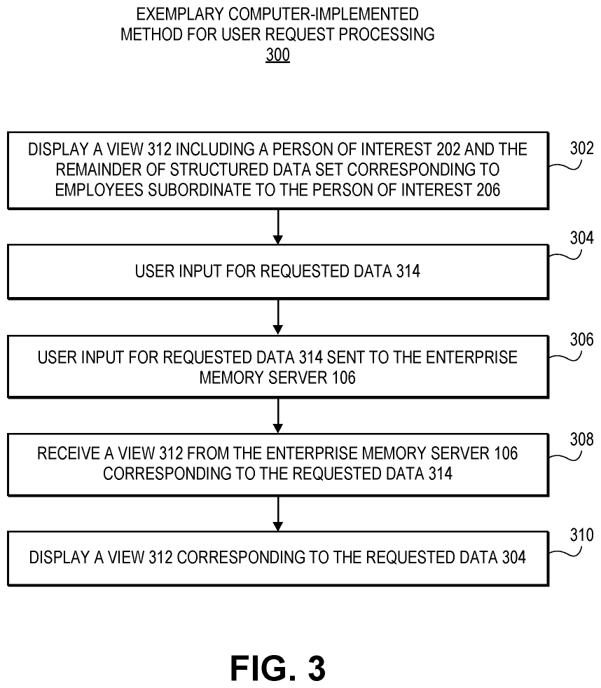

The user device 108 may be embodied by various computing devices such as a smartphone, a tablet, a laptop, a desktop computer, etc. In some embodiments the user device 108 may include aspects of one or more of the foregoing in combination, such as smartphone tablet combination (e.g., a phablet) or a tablet laptop combination (e.g., a 2-in-1 tablet laptop), etc. The user device 108 may include one or more processors 108a, the memory 108b1, and a network interface 108c. The memory 108b1 may include a user request module 108b2. The user request module 108b2 is further described in FIG. 3.

A sub-component of the exemplary computing system 100 (e.g., the user device 108) may display a view, which generally refers to a graphical user interface (GUI) for displaying the application vitals 112a to a user in conjunction with an enterprise/organizational hierarchy, on a user device. For further discussion of the view see FIG. 3.

The cloud infrastructure 102, the enterprise database 104, the enterprise memory server 106, and/or the user device 108 may be communicatively coupled by the network 110. For example, the enterprise memory server 106 and the user device 108 may communicate via universal serial bus (USB), Bluetooth, Wi-Fi Direct, Near Field Communication (NFC), etc. The enterprise memory server 106 may transmit files, documents, text, information, values, responses, etc. or combinations thereof via the network interface 106c and the network 110 to the user devices 108 via the networking interface 108c. Each of the user device 108, enterprise memory server 106, enterprise database 104, and cloud infrastructure 102 may communicate with each component of the exemplary computing environment 100 via their respective network interface 102c, 106c, 108c or otherwise.

Furthermore, the networking interfaces 102c, 106c, 108c may each support wired or wireless communications, such as universal serial bus (USB), Bluetooth, Wi-Fi Direct, Near Field Communication (NFC), etc. The networking interfaces 102c, 106c, 108c may each enable their respective components (e.g., cloud infrastructure 102, enterprise database 104, enterprise memory server 106, user device 108, etc.) to communicate with the other various components of the exemplary computing environment via a wireless communication network such as a fifth-, fourth-, or third-generation cellular network (5G, 4G, or 3G, respectively), a Wi-Fi network (802.11 standards), a WiMAX network, a wide area network (WAN), a local area network (LAN), the Internet, etc.

The network 110 may be a single communication network or a multiple communication network including one or more types (e.g., one or more wired and/or wireless personal or local area networks (PANs or LANs), and/or one or more wide area networks (WANs) such as the Internet). In some embodiments, the network 110 includes multiple, entirely distinct networks (e.g., one or more networks for communications between the cloud infrastructure 102 and the enterprise database 104 and a separate, Bluetooth or wireless LAN (WLAN) network for communications between the enterprise memory server 106 and user device 108, and so on).

In operation, the enterprise/organizational hierarchy module 102b2 causes the cloud infrastructure 102 to transmit an organizational chart (e.g., a Workday organizational chart) via the network 110 to the enterprise memory server 106. The enterprise memory server 106 queries the organizational chart for relevant members within an enterprise (e.g., Chief Executive Officer (CEO), Chief Financial Officer (CFO), department head, manager, etc.). The organizational chart and querying are further described below with respect to FIG. 4.

The application vitals pull module 106b2 causes the enterprise memory server 106 to query the cloud infrastructure 102 and enterprise database 104 in parallel for application vitals 112a corresponding to the respective applications 112 hosted thereon. The parallel processing may include multithreading in which multiple threads within a single process execute independently and may fork to create child threads to execute different parts of the program simultaneously, multiprocessing in which multiple processes may fork to create child process to run independently on different cores of a processor, shared-memory parallelism in which multiple processor share a single address space and can access and modify the same data directly, or any other suitable method of parallel processing. For further discussion of the parallel processing see FIG. 4 and FIG. 5. The application vitals pull module 106b2 stores and synchronizes the queried application vitals 112a.

The classification module 106b3 causes the enterprise memory server 106 to compare and categorize the application vitals 112a with cloud-ready assessment parameters and a trained classification model. If the application vitals 112a satisfy the cloud-ready assessment parameters the corresponding application 112 is categorized accordingly. The classification module 106b3 may include a pre trained large language model (LLM). The pre trained large language model (LLM) may be trained on data such as: the cloud-ready assessment parameters, the application vitals 112a, the organizational chart or any other data in accordance with the various embodiments described herein. The cloud-ready assessment parameters and trained classification model are discussed below in reference to FIG. 4, FIG. 6, and FIG. 7.

The user request module 108b2 causes the user device 108 to display a view including relevant members of the enterprise (e.g., CEO, CFO, a department head, a project manager, etc.) and application vitals 112a. A user inputs a request for data to the enterprise memory server 106. The enterprise memory server 106 transmits back the requested data. The user request module 108b2 causes the user device 108 to display the view corresponding to the requested data.

It should be understood that the examples in operation described above are meant to be non-limiting examples describing one exemplary embodiment of the present invention.

While in some embodiments the applications 112 and corresponding application vitals 112a are stored on the cloud infrastructure 102 and the enterprise database 104 it should be appreciated that the applications 112 and corresponding application vitals 112a may be stored in any manner in accordance with various embodiments described herein. Similarly in certain embodiments the application vitals pull module 106b2 may be located on the enterprise database 104, cloud infrastructure 102, or other similar computing device in accordance with various embodiments described herein.

It will be understood that the above disclosure with respect to FIG. 1 is one example and does not necessarily describe every possible embodiment. As such, it will be further understood that alternate embodiments may include fewer, alternate, and/or additional steps or elements. As discussed, certain modules (e.g., enterprise/organizational hierarchy module 102b2, application vitals pull module 106b2, classification module 106b3, and user request module 108b2) may be described as found within the memory (e.g., 102b1, 106b1, and 108b1) of a particular element (e.g., 102, 106, and 108) of the exemplary computing environment 100. But it should be understood that the modules may be found within the memory (e.g., 102b1, 106b1, and 108b1) of any of the elements (e.g., 102, 104, 106, and 108) of the exemplary computing environment 100 or other similarly capable computing devices.

Of course, it should be appreciated that, while the various components of the exemplary computing system 100 (e.g., cloud infrastructure 102, enterprise database 104, enterprise memory server 106, and user device 108) are illustrated in FIG. 1 as single components, the exemplary computing system 100 may include a plurality (e.g., tens, hundreds, thousands) of each of the components that are simultaneously connected to the network 110 at any given moment. Further, it is to be understood that the specific hardware/software components described in reference to FIG. 1 are for the purposes of discussion only, and that each of the components described herein in reference to FIG. 1 may take place on and/or using any suitable number of underlying hardware/software components.

As an example, a first entity may own each of the computing devices within the exemplary computing environment 100. In this example, the communication may thereby take place entirely within the set of computing devices owned by the first entity, such that external data sources and/or other external computing devices are not accessed. However, in other examples, portions of the computing devices performing the actions represented within the exemplary computing environment 100 may not be owned and/or may otherwise exist outside of the first entity's internal hardware/software architecture. To illustrate, the cloud infrastructure 102 of the exemplary computing environment 100 may be a third-party cloud-based platform (e.g., Amazon Web Services (AWS), Salesforce, Microsoft Azure, or the like).

### Exemplary Enterprise/Organizational Hierarchy

FIG. 2 depicts an exemplary enterprise/organizational hierarchy 200 for use by the exemplary computing environment 100 of FIG. 1 in accordance with various embodiments described herein. The exemplary enterprise/organizational hierarchy 200 may be stored as a structured data set to be used by the enterprise/organizational hierarchy module 102b2.

The exemplary enterprise/organizational hierarchy 200 may be stored in a variety of formats (e.g., .csv, .hdf4, .hdf5, etc.). The exemplary enterprise/organizational hierarchy 200 may be composed of a person of interest 202, a plurality of subordinates 204, and a remainder of structured data set corresponding to employees subordinate to the person of interest 206. The person of interest 202 may correspond to the leader of an organization (i.e., the top of the enterprise/organizational hierarchy 200). In an embodiment the person of interest 202 may be the CEO in charge of overseeing the entire organization such that every subordinate 204 is also included in the remainder of structured data set corresponding to employees subordinate to the person of interest 206.

In another embodiment the person of interest 202 may be a department head in charge of overseeing the corresponding subordinates 204 working within a specific department (e.g., sales, marketing, etc.). The subordinates 204 may represent project leaders overseeing members of an organization working on a specific project. The remainder of structured data set corresponding to employees subordinate to the person of interest 206 may be individual programmers or other members of the organization working on the specific project.

The subordinate 204 may correspond to anyone below the person of interest 202 within the enterprise/organizational hierarchy 200. In one embodiment the subordinate 204 may be a department head who reports to the person of interest 202 such as the CEO. In another embodiment the subordinate 204 may be a programmer that develops applications and reports to a number of other subordinates 204 such as project leaders, department heads, etc. who report to the person of interest 202 such as the CEO.

The remainder of structured data set corresponding to employees subordinate to the person of interest 206 may represent any number of subordinates 204 that report in a hierarchical fashion to the person of interest 202. In one embodiment the person of interest 202 may be a department head with a subordinate 204 representing a project leader. The project leader may have others that report to them in the form of other subordinates 204 such as individual programmers. Both the project leader and the individual programmer are encompassed by the remainder of structured data set corresponding to employees subordinate to the person of interest 206 although the individual programmer may not directly report to the person of interest 202 the department head.

### Exemplary User Request

FIG. 3 depicts an exemplary flowchart of a computer-implemented method 300 for user request processing, according to some aspects. The method 300 may be performed by the user request module 108b2 on a computing device (e.g., the user device 108) of FIG. 1 in accordance with various embodiments described herein. The method 300 generally illustrates the manner in which a user may interact with the exemplary computing environment 100 and request a particular view 312.

The method 300 may be utilized by any number of computing devices (e.g., smart phone, laptop, desktop, etc.). In some embodiments the method 300 may only be accessible to certain members of an organization such as the person of interest 202 (e.g., CEO, executive, board member, etc.).

The method 300 may include displaying a view 312 including a person of interest (e.g., the person of interest 202 of FIG. 2) and the remainder of structured data set corresponding to employees subordinate to the person of interest (e.g., the remainder of structured data set corresponding to employees subordinate to the person of interest 206 of FIG. 2) (block 302). This may represent an initial home screen that a user would see when accessing the user request module 108b2. The method 300 may include prompting the user (or otherwise, providing the user with the option/ability) to input a request for data 314 for a particular view (block 304). At block 304, the method 300 may include accessing requested data from a user device 108. The method 300 may include transmitting the requested data 314 to the enterprise memory server 106 (block 306). The enterprise memory server 106 may obtain the requested data in accordance with various embodiments described herein. The method 300 may include receiving a view 312 from the enterprise memory server 106 corresponding to the requested data 314 (block 308). The method 300 may include displaying a view 312 corresponding to the requested data 314 (block 310). At block 310, an exemplary view 312 corresponding to the requested data 314 is further depicted in FIG. 6.

In general, the requested data 312 may include a request for a specific view 312 including: a person of interest 202, a subordinate 204, an application of interest, an application vital of interest, an enterprise cloud category of interest, a cloud-ready assessment parameter of interest, and/or any combination thereof. For further illustration of the kinds of information a user may request see FIG. 6 depicting an exemplary graphical user interface (GUI).

The requested data 314 may correspond to any kind of input (e.g., text, speech, etc.) to be sent to the enterprise memory server 106. The input may be received by an email, search bar, floating action button, series of buttons pressed, any other form of proprietary request system, etc. corresponding to a particular request for data 314. In some embodiments a search bar may take as input a text query such as “show me all the applications hosted in the cloud,” or more specifically “show me all the applications hosted on AWS.” In other embodiments a floating action button may be pressed to prompt a user for similar text-based query inputs.

In another embodiment the request for data 314 may be a manual search of the view 312 such as selecting a person of interest 202, subordinate 204, etc. and navigating the view 312 for the information of interest in a manual fashion.

In one embodiment the user device 108 displays a view 312 including a person of interest 202, the remainder of structured data set corresponding to employees subordinate to the person of interest 206, and the associated application vitals 112a. A user such as a department head enters an input for requested data 314 such as “show me how many sales applications are ready to migrate to AWS.” The user input for requested data 314 is then sent to the enterprise memory server 106. The enterprise memory server 106 then transmits a view 312 corresponding to the requested data 314 back to the user device 108. The user device 108 then displays the view 312 to the user.

As discussed, the method 300 may correspond to the flow or steps of the user request module 108b2. However, it should be understood that the flow or steps illustrated in the method 300 are not an exhaustive list of the embodiments described herein but merely an illustration of a particular nonlimiting embodiment.

### Exemplary Enterprise/Organizational Hierarchy and Application Vitals Retrieval

FIG. 4 depicts an exemplary flowchart of a computer-implemented method 400 for enterprise/organizational hierarchy and application vitals retrieval, according to some aspects. The method 400 generally illustrates the steps/flow used by the enterprise/organizational hierarchy module 102b2, the application vitals pull module 106b2, and the classification module 106b3.

In an embodiment the enterprise memory server 106 receives a structured data set 412 such as that depicted in FIG. 2 as an exemplary enterprise/organizational hierarchy 200 from the cloud infrastructure 102 via the network 110 (block 402). As depicted block 402 may be an optional step in some embodiments such as when the structured data set 412 does not need to be updated. The enterprise memory server 106 queries the structured data set 412 for a person of interest 202 (block 404. Again, as depicted, this may be an optional step. The enterprise memory server 106 queries the cloud infrastructure 102 and enterprise database 104 in parallel 414 for application vitals 112a (block 406). The enterprise memory server 106 stores and synchronizes the application vitals 112a received (block 408). The enterprise memory server 106 compares and categorizes the application vitals 112a with cloud-ready assessment parameters 416 and a trained classification module 418 (block 410).

The querying of the structured data set may employ methods such as pre-order, in-order, or post-order traversal or another suitable means of searching the structured data set. The enterprise memory server 106 queries the cloud infrastructure 102 and enterprise database 104 for application vitals 112a in parallel. The parallel processing is further illustrated below with respect to FIG. 5.

In general, the method 400 may query the cloud infrastructure 102 and/or the enterprise database 104 for application vitals 112a in batches, periodically, on a scheduled basis, on user input, and/or any combination thereof.

In an embodiment the enterprise memory server 106 stores and synchronizes the application vitals 112a received so that the enterprise memory server 106 may compare and categorize the application vitals 112a with cloud-ready assessment parameters 416 and a trained classification model 418. The cloud-ready assessment parameters 416 are further illustrated below with respect to FIG. 6 and FIG. 7.

In certain embodiments the trained classification module 418 may include a pretrained large language model like a ChatGPT customized GPT model. In certain embodiments the pre trained large language model may be a neural network with a layer of nodes trained to output a predicted intended view 312. The predicted intended view 312 corresponds to the output of the pre trained large language model based on the user input for requested data 314. In an embodiment a user input for requested data 314 might be a text input such as: “how many of Jane Doe's applications are AWS ready?” The pretrained large language model may interpret the text query and output an intended view for just the application vitals authored by subordinate 204 Jane Doe that meet the cloud ready assessment parameters for Amazon Web Services.

In another embodiment there may not be a pre trained large language model and so a user input for requested data 314 might be the selection of a particular subordinate 204 on the view 312. The categorization of the application vitals 112a may include only categorizing application vitals 112a in which a specified author, contributor, etc. is selected and then displayed in the view 312.

Again, it should be understood that the flow or steps illustrated in the method 400 are not an exhaustive list of the embodiments described herein but merely an illustration of a number of particular nonlimiting embodiments.

### Exemplary Parallel Computing Environment

FIG. 5 depicts an exemplary parallel computing environment 500 for processing application vitals 112a of FIG. 1 in accordance with various embodiments described herein.

In general, the parallel computing environment 500 includes the enterprise database 104, the cloud infrastructure 102, and the enterprise memory server 106. The enterprise memory server 106 includes one or more memory 106b1 further including one or more ram banks (e.g., 502a, 502b, etc.) as well as one or more processors 106a further including one or more computer processing unit (CPU) chips (e.g., 504a, 504b). The ram bank 502a and 502b may be any number of short-term memory devices utilizing technology like DDR4, DDR5, etc. The CPU chip 504a and 504b may be any number of computer processing chips (e.g., Intel i7, i9 or AMD Ryzen 7, Ryzen 9, etc.).

The CPU chips 504a and 504b may be multicore and/or multithreaded processors capable of implementing the embodiments described herein. The parallel computing environment 500 may generally be utilized by the application vitals pull module 106b1 (e.g., in parallel 411). The parallel computing environment 500 may employ various methods of parallel processing such as multithreading, multiprocessing, shared-memory parallelism, distributed-memory parallelism, data parallelism, single instruction multiple data (SIMD), multiple instruction multiple data (MIMD), single program multiple data (SPMD), or the like.

In an embodiment the parallel computing environment 500 may be executed on the enterprise memory server 106. The enterprise memory server 106 may query the cloud infrastructure 102 and the enterprise database 104 in parallel such that the application vitals are processed simultaneously on the different processers 106a/CPU chips 504a and 504b in the parallel computing environment 500.

In another embodiment the parallel computing environment 500 may utilize multithreading by establishing a main thread connection to the cloud infrastructure 102 and the enterprise database 104. Two child threads may be created and assigned to the cloud infrastructure 102 and the enterprise database 104 respectively. The two child threads may be assigned a query for application vitals 112a to execute concurrently. Each thread retrieves the application vitals 112a of their respective query and aggregates the application vitals 112a in the main thread.

In another embodiment the parallel computing environment 500 may utilize multiprocessing by establishing a main process connection to the cloud infrastructure 102 and the enterprise database 104. Two child processes may be created and assigned to the cloud infrastructure 102 and the enterprise database 104 respectively. The two child processes may be assigned a query for application vitals 112a to execute independently on different cores. Each process retrieves the application vitals 112a of their respective query and stores the application vitals 112a in their respective memory spaces (e.g., Ram bank 502a corresponding to the process executing on a core of CPU Chip 504a and Ram bank 502b corresponding to the process executing on a core of CPU chip 504b). The main process communicates with each child process to retrieve and aggregate the application vitals 112a from the query.

### Exemplary Graphical User Interfaces (GUIs)

FIG. 6A depicts an exemplary graphical user interface (GUI) 600 for use by the user request module 108b2 of FIG. 1 in accordance with various embodiments described herein. The exemplary graphical user interface 600 may include a person of interest 202, a subordinate 204, a remainder of structured data set corresponding to employees subordinate to the person of interest 206, applications 112, and applications vitals 112a.

In some embodiments the exemplary graphical user interface 600 includes a number and a percentage of cloud-ready assessment parameters 416 such as: total applications 602, cloud hosted applications 604, cloud capable applications 606, future cloud implemented applications 608, applications to be retained 610, applications to be retired 612, and/or uncategorized applications 614. The cloud-ready assessment parameters 416 are further depicted with respect to FIG. 6B.

FIG. 6B depicts an exemplary list of cloud-ready assessment parameters 416 as discussed with reference to FIG. 6A. In one embodiment the cloud-ready assessment parameter for uncategorized 614 may be any applications 112 that do not meet any of the other cloud-ready assessment parameters 416 (e.g., cloud hosted 604, cloud capable 606, future cloud 608, retain 610, and retire 612).

### Additional Considerations

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

The systems and methods described herein are directed to an improvement to computer functionality, and improve the functioning of conventional computers. Additionally, certain embodiments are described herein as including logic or a number of routines, subroutines, applications, or instructions. These may constitute either software (e.g., code embodied on a non-transitory, machine-readable medium) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, and/or may be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules include a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single computer, but deployed across a number of computers. In some example embodiments, the processor or processors may be located in a single location (e.g., within a home environment, an office environment or as a server farm), while in other embodiments the processors may be distributed across a number of locations.

The performance of certain of the operations may be distributed among the one or more processors, not only residing within a single computer, but deployed across a number of computers. In some example embodiments, the one or more processors or processor-implemented modules may be located in a single geographic location (e.g., within an offices enterprise server environment). In other example embodiments, the one or more processors or processor-implemented modules may be distributed across a number of geographic locations (e.g., various cloud computing servers).

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based upon any statement made in any section of this patent (other than the language of the claims). To the extent that any term recited in the claims at the end of this disclosure is referred to in this disclosure in a manner consistent with a single meaning, that is done for sake of clarity only so as to not confuse the reader, and it is not intended that such claim term be limited, by implication or otherwise, to that single meaning.

Unless specifically stated otherwise, discussions herein using words such as “processing,” “computing,” “determining,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other components that receive, store, transmit, or display information.

As used herein any reference to “one embodiment,” “a particular embodiment,” “an embodiment,” or the like means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still cooperate or interact with each other (e.g., communicatively coupled). The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also may include the plural unless it is obvious that it is meant otherwise.

This detailed description is to be construed as examples and does not describe every possible embodiment, as describing every possible embodiment would be impractical, if not impossible. One could implement numerous alternate embodiments, using either current technology or technology developed after the filing date of this application.

Upon reading this disclosure, those of skill in the art will appreciate additional alternative structural and functional designs for evaluation properties, through the principles disclosed herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The patent claims at the end of this patent application are not intended to be construed under 35 U.S.C. § 112(f) unless traditional means-plus-function language is expressly recited, such as “means for” or “step for” language being explicitly recited in the claim(s). The systems and methods described herein are directed to an improvement to computer functionality, and improve the functioning of conventional computers.

What is claimed is:

1. A computer-implemented method for visualizing application vitals, the method comprising:
receiving, by one or more processors, a structured data set;
querying, by the one or more processors, the structured data set for a person of interest;
causing a user device to display a view including:
(i) the person of interest, and
(ii) at least a portion of the structured data set corresponding to employees subordinate to the person of interest;
querying, by the one or more processors, a cloud infrastructure and/or an enterprise database in parallel,
wherein the querying includes:
(i) retrieving a plurality of application vitals from a plurality of enterprise applications with respect to the cloud infrastructure, and
(ii) retrieving a plurality of application vitals from the plurality of enterprise applications with respect to the enterprise database,
wherein, the application vitals include a plurality of health statistics with respect to the plurality of enterprise applications;
storing, by an enterprise memory server, the plurality of application vitals from the plurality of enterprise applications;
synchronizing, by the one or more processors, the plurality of application vitals from the plurality of enterprise applications with the enterprise memory server;
comparing, by the one or more processors, the plurality of application vitals with a plurality of cloud-ready assessment parameters;
generating one or more cloud categories corresponding to the enterprise applications by processing the application vitals and the cloud-ready assessment parameters using a trained classification model;
receiving, requested data from a user device;
updating, by the one or more processors, the view to include the requested data; and
causing the user device to display the view.

2. The computer-implemented method of claim 1,
wherein querying the cloud infrastructure and/or the enterprise database in parallel includes querying the cloud infrastructure and/or the enterprise database (i) in batches, (ii) on a periodic basis, and/or (iii) on a scheduled basis.

3. The computer-implemented method of claim 1, further comprising:
pre-training a large language model wherein the training includes processing a set of data that can be included in the view.

4. The computer-implemented method of claim 3, further comprising:
receiving, by the one or more processors, a desired view in a text query from the user input;
processing, by the pre-trained large language model, the text query from the user input to generate a predicted desired view based on an intent of the text query from the user input;
updating, by the one or more processors, the view to include a predicted desired view; and
displaying the view.

5. The computer-implemented method of claim 1, wherein the cloud categories include a number and a percentage of at least one of:
(i) total applications,
(ii) cloud hosted applications,
(iii) cloud capable applications,
(iv) future cloud implemented applications,
(v) applications to be retained,
(vi) applications to be retired; or
(vii) uncategorized applications.

6. The computer-implemented method of claim 1, wherein the structured data set is representative of an enterprise/organizational hierarchy.

7. The computer-implemented method of claim 1, wherein the requested data includes at least one of:
(i) the person of interest,
(ii) an application of interest,
(iii) an application vital of interest,
(iv) an enterprise cloud category of interest; or
(v) a cloud-ready assessment parameter of interest.

8. A computing system for visualizing application vitals, comprising:
one or more processors; and
one or more memories having stored thereon instructions that, when executed by the one or more processors, cause the system to:
receive a structured data set;
query the structured data set for a person of interest;
cause a user device to display a view including:
(i) the person of interest, and
(ii) at least a portion of the structured data set corresponding to employees subordinate to the person of interest;
query a cloud infrastructure and/or an enterprise database in parallel,
wherein the querying includes:
(i) performing a retrieval of a plurality of application vitals from a plurality of enterprise applications with respect to the cloud infrastructure, and
(ii) performing a retrieval of a plurality of applications vitals from the plurality of enterprise applications with respect to the enterprise database,
wherein the application vitals include a plurality of health statistics with respect to the plurality of enterprise applications;
store the plurality of application vitals from the plurality of enterprise applications;
synchronize the plurality of application vitals from the plurality of enterprise applications with an enterprise memory server;
compare the plurality of application vitals with a plurality of cloud-ready assessment parameters;
generate one or more cloud categories corresponding to the enterprise applications by processing the application vitals and the cloud-ready assessment parameters using a trained classification model;
receive, by a user device, requested data in a text query from a user input;
update the view to include the requested data; and
cause the user device to display the view.

9. The computing system of claim 8, the one or more memories having stored thereon instructions that, when executed, cause the one or more processors to:
query the cloud infrastructure and/or the enterprise database in parallel,
(i) in batches,
(ii) on a periodic basis, and/or
(iii) on a scheduled basis.

10. The computing system of claim 8, the one or more memories having stored thereon instructions that, when executed, cause the one or more processors to:
pre-train a large language model wherein the training includes processing a set of data that can be included in the view.

11. The computing system of claim 10, the one or more memories having stored thereon instructions that, when executed, cause the one or more processors to:
receive a desired view in the text query from the user input;
processing, by the pre-trained large language model, the text query from the user input to generate a predicted desired view based on an intent of the text query from the user input;
update the view to include the predicted desired view;
cause a user device to display the view;

12. The computing system of claim 8, wherein the one or more cloud categories include a number and a percentage of at least one of:
(i) total applications,
(ii) cloud hosted applications,
(iii) cloud capable applications,
(iv) future cloud implemented applications,
(v) applications to be retained,
(vi) applications to be retired; or
(vii) uncategorized applications.

13. The computing system of claim 8, wherein the structured data set is representative of an enterprise/organizational hierarchy.

14. The computing system of claim 8, wherein the requested data includes at least one of:
(i) the person of interest,
(ii) an application of interest,
(iii) an application vital of interest,
(iv) an enterprise cloud category of interest; or
(v) a cloud-ready assessment parameter of interest.

15. A non-transitory computer-readable medium having stored thereon instructions that, when executed by one or more processors, cause a computer to at least:
receive a structured data set;
query the structured data set for a person of interest;
cause a user device to display a view including:
(i) the person of interest, and
(ii) at least a portion of the structured data set corresponding to employees subordinate to the person of interest;
query a cloud infrastructure and/or an enterprise database in parallel,
wherein the querying includes:
(i) performing a retrieval of a plurality of application vitals from a plurality of enterprise applications with respect to the cloud infrastructure, and
(ii) performing a retrieval of a plurality of applications vitals from the plurality of enterprise applications with respect to the enterprise database,
wherein the application vitals include a plurality of health statistics with respect to the plurality of enterprise applications;
store the plurality of application vitals from the plurality of enterprise applications;
synchronize the plurality of application vitals from the plurality of enterprise applications with an enterprise memory server;
compare the plurality of application vitals with a plurality of cloud-ready assessment parameters;
generate one or more cloud categories corresponding to the enterprise applications by processing the application vitals and the cloud-ready assessment parameters using a trained classification model;
receive requested data in a text query from a user input;
update the view to include the requested data; and
cause the user device to display the view.

16. The non-transitory computer-readable medium of claim 15, having stored thereon instructions that, when executed, cause a computer to at least:
query the cloud infrastructure and/or the enterprise database in parallel,
(i) in batches,
(ii) on a periodic basis, and/or
(iii) on a scheduled basis.

17. The non-transitory computer-readable medium of claim 15, having stored thereon instructions that, when executed, cause a computer to at least:
pre-train a large language model wherein the training includes processing a set of data that can be included in the view.

18. The non-transitory computer-readable medium of claim 17, having stored thereon instructions that, when executed, cause a computer to at least:
receive a desired view in the text query from the user input;
processing, by the pre-trained large language model, the text query from the user input to generate a predicted desired view based on an intent of the text query from the user input;
update the view to include the predicted desired view;
cause a user device to display the view;

19. The non-transitory computer-readable medium of claim 15, wherein the cloud categories include a number and a percentage of at least one of:
(i) total applications,
(ii) cloud hosted applications,
(iii) cloud capable applications,
(iv) future cloud implemented applications,
(v) applications to be retained,
(vi) applications to be retired; or
(vii) uncategorized applications.

20. The non-transitory computer-readable medium of claim 15, wherein the structured data set is representative of an enterprise/organizational hierarchy.
